(19) United States
(12) Patent Application Publication
(10) Pub. No.: US 2004/0031096 A1
(43) Pub. Date: Feb. 19, 2004

(54) Hoisting harness

(76) Inventor: Gunnar Liljedahl, Lulea (SE)

Correspondence Address: JACOBSON HOLMAN PLLC, 400 SEVENTH STREET N.W., SUITE 600, WASHINGTON, DC, 20004, US

(21) Appl. No.: 10/363,702

(22) PCT Filed: Sep. 19, 2001
(86) PCT No.: PCT/SE01/02006

(30) Foreign Application Priority Data
Nov. 29, 2000 (SE) 0004396-8

(51) Int. Cl. A61G 7/00; B66C 1/12

(52) U.S. Cl. 5/89.1; 294/74

(57) ABSTRACT

Hoisting harness for persons, where the lifting action takes place by a harness consisting of a seat-piece (1) placed between the person's legs, to which seat-piece a rear-piece (3) is connected, which runs against the persons's back and further consists of a front piece (15) which runs against the chest. The front-piece (15) and the rear-piece (3) in their free ends have loops (8, 9, 17, 18) to be applied to a lift means, e.g. a lift hanger (19). In order to avoid that the harness shall not be too tight across the chest during the lifting action and that the harness is adaptable to the size of the person's body, the front-piece (15) and the rear-piece (3) are connected by two connecting bands (11, 12) each band passing one side of the body, whereby the length of the connecting bands (11, 12) between by the front-piece and the rear-piece (3) is adjustable.

This invention relates to a hoisting harness for persons, where the lifting action is taken place by a hoisting harness consisting of a seat-piece, which is placed between the person's legs, to which seat piece a rear-piece is connected, which runs on the person's back and upwards over the shoulders and further consists of a front piece, which runs against the person's breast and upwards over the shoulders, whereby the front piece and the rear piece have loops, or the corresponding, protruding from their free ends, which loops will be applied to a lift means e.g. a lift hanger.

Hoisting harnesses of this kind are very often so formed that when a person is lifted sitting in the harness, pressure on the chest or against the person's sides will be created and this specifically goes for heavy persons having a corpulent body. The problem is very obvious when lifting disabled persons, old persons or weak persons, who can not use their hands to keep off the tension forces of the hoisting harness.

An object of the invention is thus to design a hoisting harness, which is comfortable for the lifted person during the lifting action and thereby will not be tight across the chest or at another point of the body and which can be adapted to the size of the person's body.

The invention is hereby characterized according to the features stated in the enclosed claims.

An embodiment of the invention will now be described with reference to enclosed drawings.

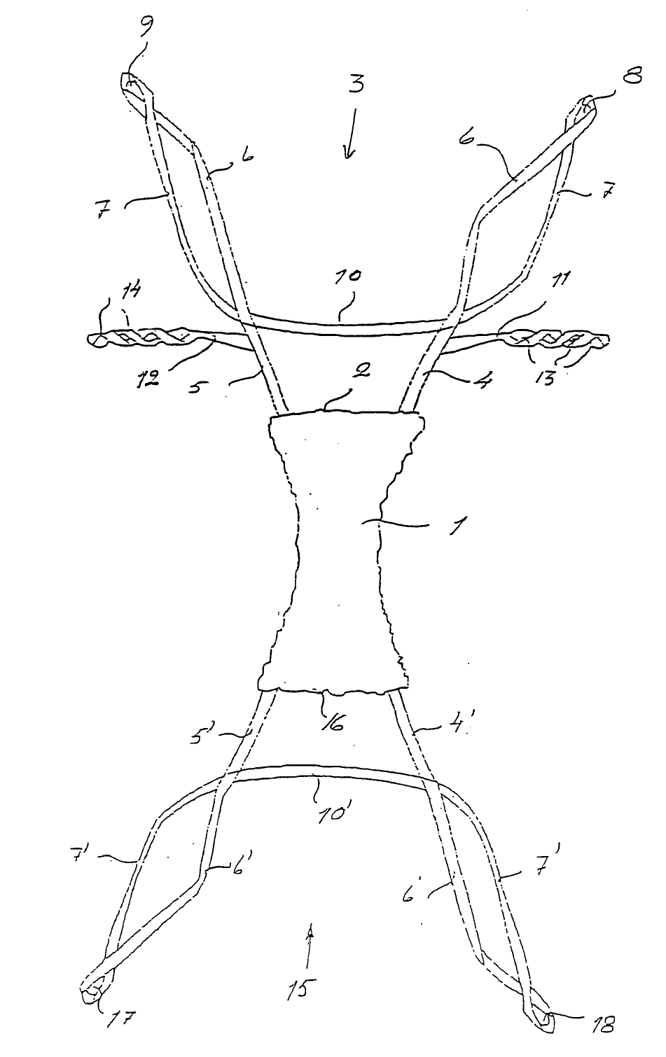

FIG. 1 is hereby a plan view of the harness.

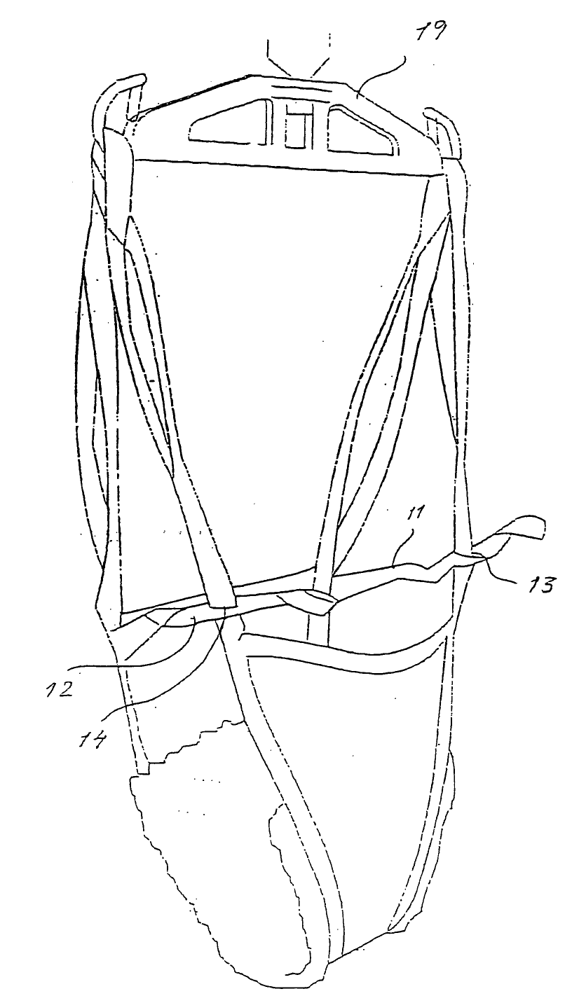

FIG. 2 is a harness according to the invention hanging from a lift hanger without a person being lifted.

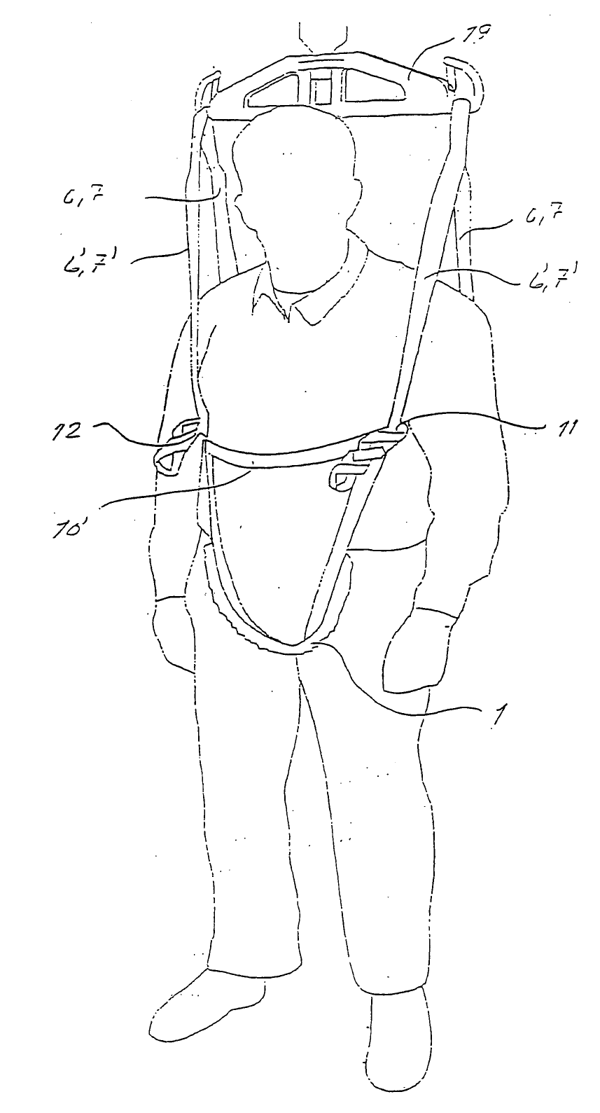

FIG. 3 is a view showing a person being lifted by the harness according to the invention, the harness hanging from a lift hanger.

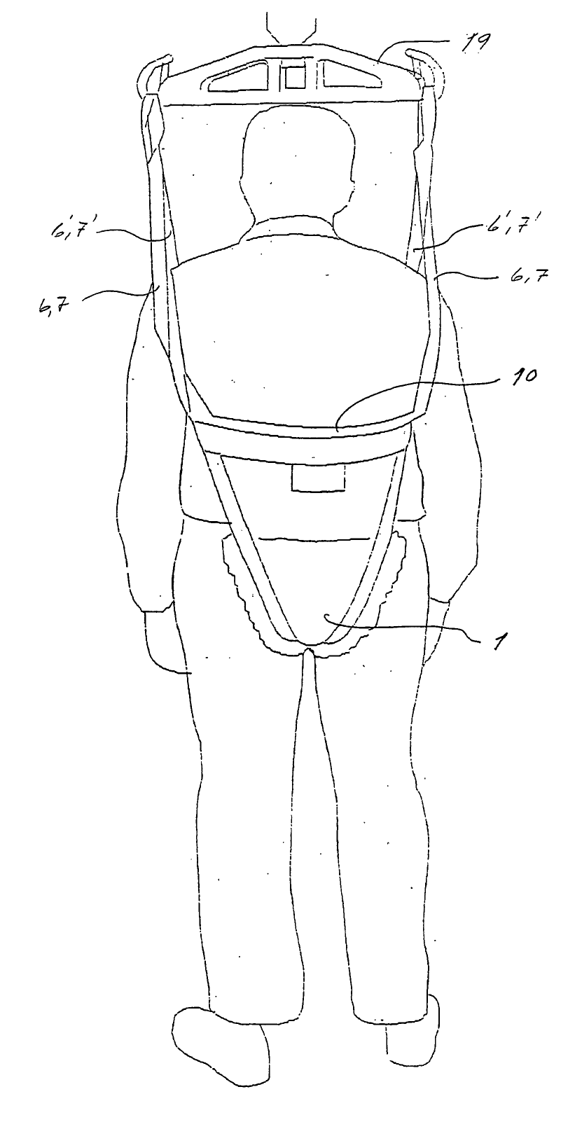

FIG. 4 is the same as FIG. 3 but the person being lifted is seen from backwards.

FIG. 1 is thus a plan view of the harness. The harness includes a seat-piece 1 in the form of a piece of a cloth, which is placed between the person's legs. A rear-piece, generally designated by 3 is fastened to the rear end 2 of the seatpiece. This rear-piece 3 consists of two hoisting bands 4 and 5, which are prolonged by two parts 6 and 7, which in their upper ends form a loop 8 and 9 respectively. The hoisting bands 4 and 5 are transversally connected by a transverse band 10.

Two connecting bands 11 and 12 are connected with the hoisting bands 4 and 5 at points approximately where the transverse band 10 is connected to the hoisting bands 4 and 5. The two connecting bands 11 and 12 are composed of several loops 13 and 14 respectively at their free ends.

The hoisting harness has also a front piece generally indicated by 15. This front piece is connected to the front end 16 of the seat piece and is principally formed in the same way as the rear piece, why it is not described more closely, and the corresponding parts are indicated by the same numerals with prime as what is described concerning the rear piece. However, as shown in FIG. 1, the front-piece 15 has two lifting loops and they are designated by 17 and 18.

In FIG. 2 the harness is shown hanging from a lifting hanger 19. In this form the harness is hanging in the loops 8, 9, 17 and 18. In order to give the harness a closed form the hoisting bands 6′ and 7′ of the front piece 15 are inserted through any of the loops 12 and 13 respectively of the connecting bands 11 and 12 respectively. A closed harness is thus formed around the person's body by the rear piece 3, the front piece 15 and the two connecting bands 11 and 12, see also FIG. 3. The seat-piece is also included in this closed form of the harness.

From FIG. 3 it can be seen that the connecting bands 11 and 12 are placed under the armpits and preferably at a certain distance from the armpits so that the connecting bands do not press uncomfortably into the armpits. By that the connecting bands 11 and 12 can be inserted in suitable loops 12 and 13, it is possible to place the transverse bands 10 and 10′ so far from each other that they are not uncomfortably tightened against the chest and the back when the lifting action takes place. The lifting bands will be stretched during the lifting operation, which can have an influence on the tension of the transverse bands 10 and 10′. It should also be observed that the main part of the person's weight will be carried by the seat-piece 1. It is also possible to adapt the harness so that the weight is divided between the seat-piece and the connecting bands by that the latter carry in the armpits. Further, it is also possible that the-weight can be carried by the transverse bands 10 and 10′ respectively because of a friction between them and the body.

An embodiment has been described above but within the scope of the claims other embodiments are possible. Thus, the front piece and the rear piece have been described consisting of bands but it is obvious that parts of the front piece and the rear piece can be formed from pieces of cloths instead of bands, at least as far as up to the transverse bands.

1. Hoisting harness for persons, where the lifting action takes place by a harness consisting of a seat piece (1) placed between the person's legs, to which seat-piece a rear-piece (3) is connected, which runs against the person's back and upwards over the shoulders and which harness further consists of a front piece (15), which runs against the chest of the person and upwards over the shoulders, whereby the front piece (15) and rear piece (3) in their free ends have loops (8, 9, 17, 18) to be applied to a lift means, e.g. a lift hanger (19), characterized in, that a connecting band (11, 12) protrudes from each side of the rear piece (3), the free end of each connecting band (11, 12) having several loops (13, 14) after each other, whereby from each side of the front piece (15) a lifting band (6′, 7′) protrudes, which lifting band, in accordance with the size of the person's body, can be inserted through one loop (13, 14), of the lifting band (11, 12) which makes that the person in a comfortable way is sitting on the seat-piece surrounded by the rear-piece (3), the front-piece (15) and the two connecting bands (11, 12).

2. Hoisting harness according to claim 1, characterized in, that the rear-piece (3) as well as the front-piece (15) each consists of two hoisting bands, which are doubled (6, 7, 6′, 7′) from a point where the transverse band (10, 10′) connects the hoisting bands.

3. Hoisting harness according to claim 1, characterized in, that the connecting bands (11, 12) are fastened to the rear-piece (3) so that they are at a small distance under the person's armpits, when the connecting bands (11, 12) connect the rear-piece (3) with the front-piece (15).
